(19) United States
(12) Patent Application Publication
(10) Pub. No.: US 2015/0203006 A1
(43) Pub. Date: Jul. 23, 2015

(54) VEHICLE DOOR ARMREST

(71) Applicant: Johnson Controls Technology Company, Holland, MI (US)

(72) Inventors: Jason M. Hipshier, Hudsonville, MI (US); David J. McCarthy, Holland, MI (US); Arne Dassen, Holland, MI (US); Randy Vanhoof, Zeeland, MI (US); Kyle B. Beeck, Grand Haven, MI (US); Andrew Robert Butz, Holland, MI (US); Stanton Paul Boyer, Zeeland, MI (US)

(21) Appl. No.: 14/418,068

(22) PCT Filed: Jul. 31, 2013
(86) PCT No.: PCT/US13/53039

§ 371 Date: Jan. 28, 2015

Related U.S. Application Data
(60) Provisional application No. 61/678,943, filed on Aug. 2, 2012.

(51) Int. Cl. B60N 2/46; B60R 7/04

(52) U.S. Cl. CPC B60N 2/4646; B60N 2/466; B60R 7/04

(57) ABSTRACT

An armrest for a door of a motor vehicle. A motor vehicle includes a vehicle door assembly. Further, the vehicle door assembly includes a support structure. Moreover, the vehicle door assembly also includes an armrest slidably coupled to the support structure. The armrest may slide along the door assembly to adjust its position.

### CROSS REFERENCE TO RELATED APPLICATION

This application claims priority from and the benefit of U.S. Provisional Application Ser. No. 61/678,943, entitled “VEHICLE DOOR ARMREST”, filed Aug. 2, 2012, which is hereby incorporated by reference in its entirety.

### BACKGROUND

The invention relates generally to motor vehicles, and more particularly, to an armrest for a door of a motor vehicle.

An armrest is a device found in many vehicles on which occupants may rest their arms. Seats of a vehicle that have armrests may include one or two armrests. The number of armrests per seat may depend on the location of the seat, the position of the seat relative to other seats, and so forth. An armrest may be rotatably attached to a seat so that the armrest may be raised when not in use and lowered for use. Furthermore, in certain seating arrangements, an armrest may be built into a door panel of the vehicle. Armrests that are built into a door panel are generally part of a rigid door structure, and may include certain vehicle controls, such as window controls, locking controls, and so forth. In addition, such armrests may house a handle for opening the door, and/or a grip area to aid an occupant in closing the door. Unfortunately, an armrest that is built into a door generally does not enable an occupant to adjust its position. Therefore, the occupant may find such an armrest uncomfortable.

### BRIEF DESCRIPTION OF THE INVENTION

The present invention relates to a vehicle door assembly including a support structure. The vehicle door assembly also includes an armrest slidably coupled to the support structure.

The present invention also relates to an armrest assembly including a substrate having a first surface and a second surface. The first surface includes a notch extending along the first surface in a transverse direction relative to a longitudinal direction, and the notch extends substantially parallel to a plane formed by the first surface.

The present invention further relates to a vehicle door assembly including a slidable armrest. The slidable armrest is configured to move in a substantially horizontal direction relative to a longitudinal axis of the vehicle door assembly.

### DRAWINGS

FIG. 1 is a perspective view of an exemplary vehicle that may include an armrest slidably coupled to a door assembly of a vehicle.

FIG. 2 is a perspective view of an embodiment of an armrest slidably coupled to a door assembly of a vehicle with the armrest in an aft position.

FIG. 3 is a perspective view of an embodiment of the armrest of FIG. 2 with the armrest in a forward position.

FIG. 4 is a side view of an embodiment of an armrest configured for linear movement.

FIG. 5 is a side view of an embodiment of an armrest configured for non-linear movement.

FIG. 6 is a cross-sectional view of an embodiment of the armrest of FIG. 2.

FIG. 7 is a cross-sectional view of another embodiment of the armrest of FIG. 2.

### DETAILED DESCRIPTION

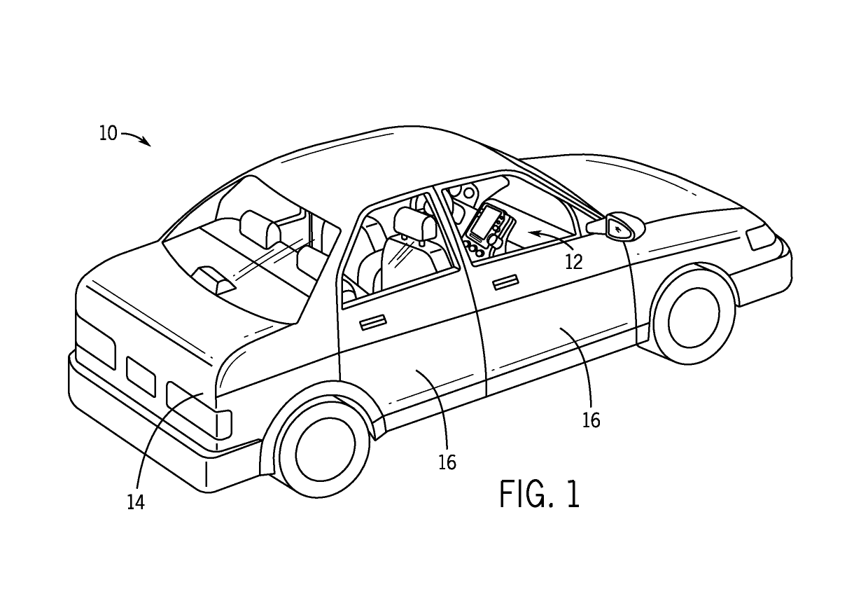

FIG. 1 is a perspective view of an exemplary vehicle 10 that may include an armrest slidably coupled to a door assembly of the vehicle. The vehicle 10, in this case a car, includes an interior 12 and an exterior 14. Furthermore, the vehicle 10 includes one or more door assemblies 16. As may be appreciated, a portion of each door assembly 16 is exposed to the interior 12 of the vehicle 10, and a portion of each door assembly 16 is exposed to the exterior 14 of the vehicle 10. Certain door assemblies 16 may include an armrest slidably coupled to the door assembly 16. The armrest may be configured to slide in a substantially horizontal direction relative to a longitudinal axis of the door assembly 16. In some embodiments, the armrest may be manufactured from a rigid material, and may move in a substantially linear horizontal path. In other embodiments, the armrest may be manufactured from a flexible material, and may move in a non-linear path that is generally horizontal, but also includes a vertical component. With the slidable armrest, an occupant of the vehicle 10 may adjust the armrest to a desired position. Furthermore, in certain embodiments, the slidable armrest may be configured to cover at least a portion of an opening in a storage compartment. As such, the slidable armrest may selectively facilitate access to the storage compartment.

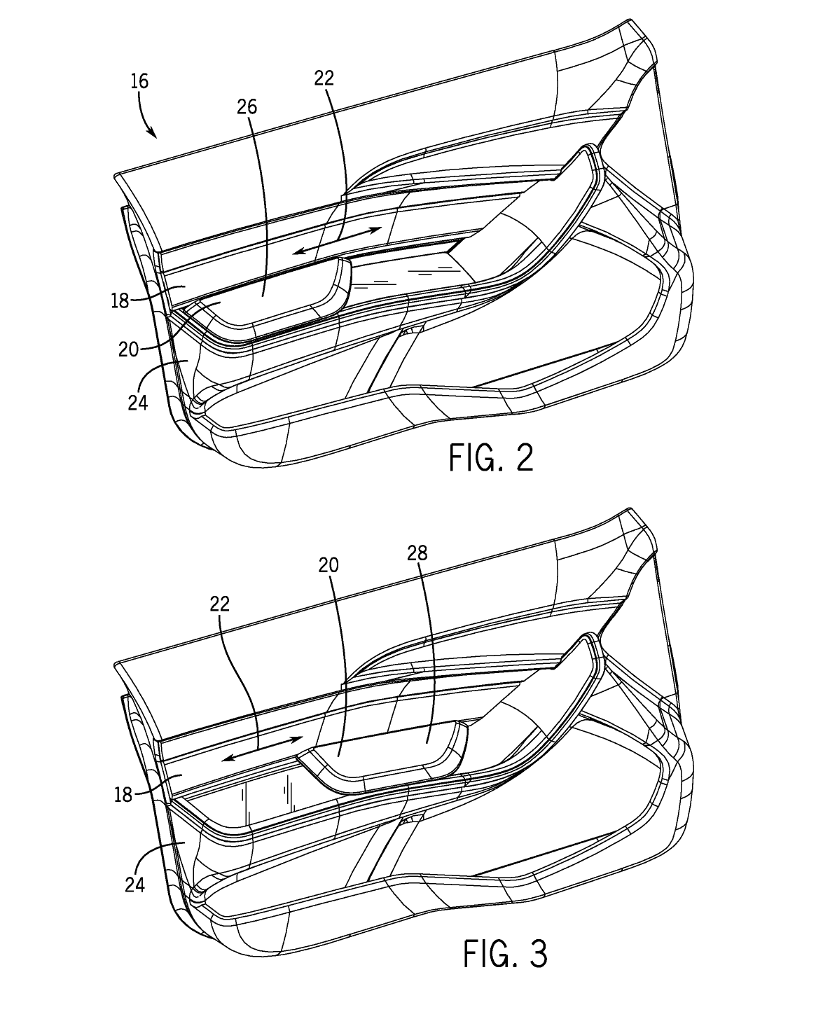

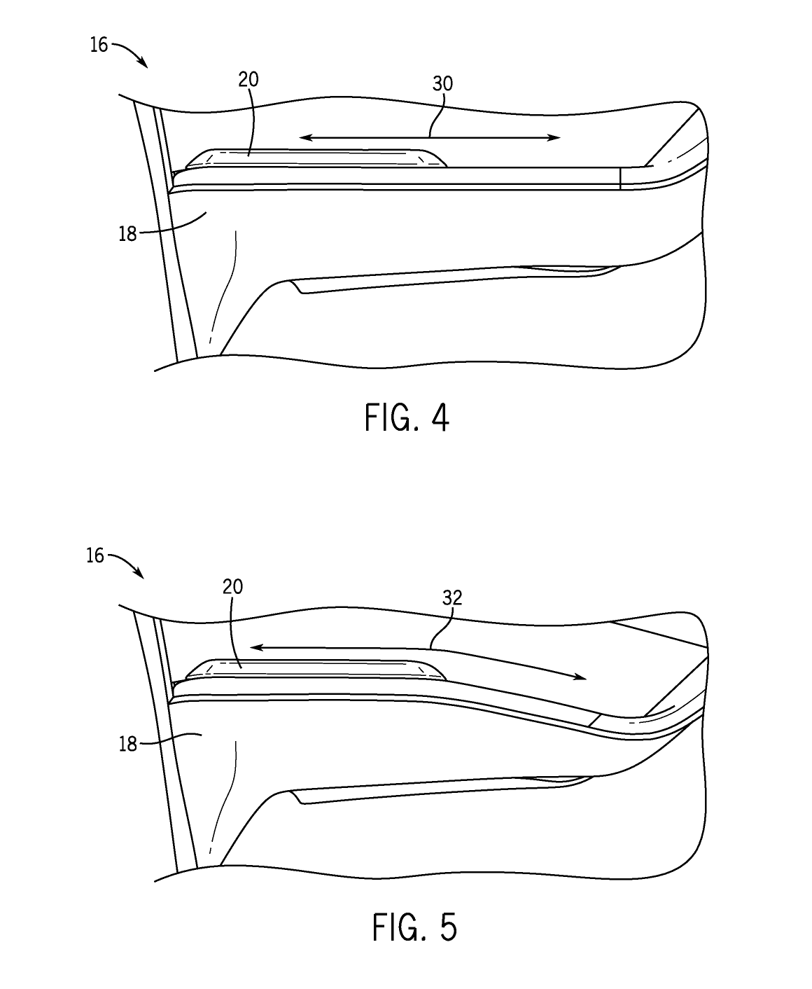

FIG. 2 is a perspective view of an embodiment of an armrest slidably coupled to the door assembly 16 of the vehicle 10 with the armrest in an aft position. As illustrated, the door assembly 16 includes a support structure 18 that provides structural support to the components of the door assembly 16. For example, the support structure 18 is configured to structurally support an armrest 20. In the present embodiment, the armrest 20 is slidably coupled to the support structure 18. Arrows 22 illustrate a direction of movement of the armrest 20. As may be appreciated, the armrest 20 may slide in a substantially horizontal direction relative to a direction of travel of the vehicle 10 (e.g., along a longitudinal axis of the door assembly 16). In the present embodiment, the armrest 20 is located vertically above a storage compartment 24, thereby forming a lid of the storage compartment 24. In other embodiments, the armrest 20 may only partially cover a storage compartment. In further embodiments, the storage compartment may be omitted, and the armrest 20 may slide along a surface of the door assembly 16. In certain embodiments, the armrest 20 may be configured to provide structural support for loading (e.g., vertical, horizontal, etc.). As illustrated, the armrest 20 is positioned in an aft position 26. By sliding the armrest 20 along the door assembly 16 in a forward direction the armrest 20 may be moved from the aft position 26 to a forward position 28, as illustrated in FIG. 3. Furthermore, the armrest 20 may slide to any position desired by an occupant of the vehicle 10 between the aft and forward positions 26 and 28. As may be appreciated, changing the position of the armrest 20 may open a storage compartment to facilitate access and/or close the storage compartment to block access. Moreover, by having the slidable armrest 20, the occupant of the vehicle 10 may position the armrest 20 to facilitate occupant comfort.

FIG. 4 is a side view of an embodiment of an armrest 20 configured for linear movement. Accordingly, the armrest 20 may be manufactured from a rigid material and may move in a substantially linear horizontal path 30. In certain embodiments, the armrest 20 may be manufactured from a flexible material and may move in a substantially linear horizontal path 30. In contrast, FIG. 5 is a side view of an embodiment of an armrest 20 configured for non-linear movement. As such, the armrest 20 may be manufactured from a flexible material and may move in a non-linear path 32 that is generally horizontal, but also includes a vertical component. Therefore, the armrest 20 may be designed based on a desired mounting configuration, and for a variety of different door assemblies 16.

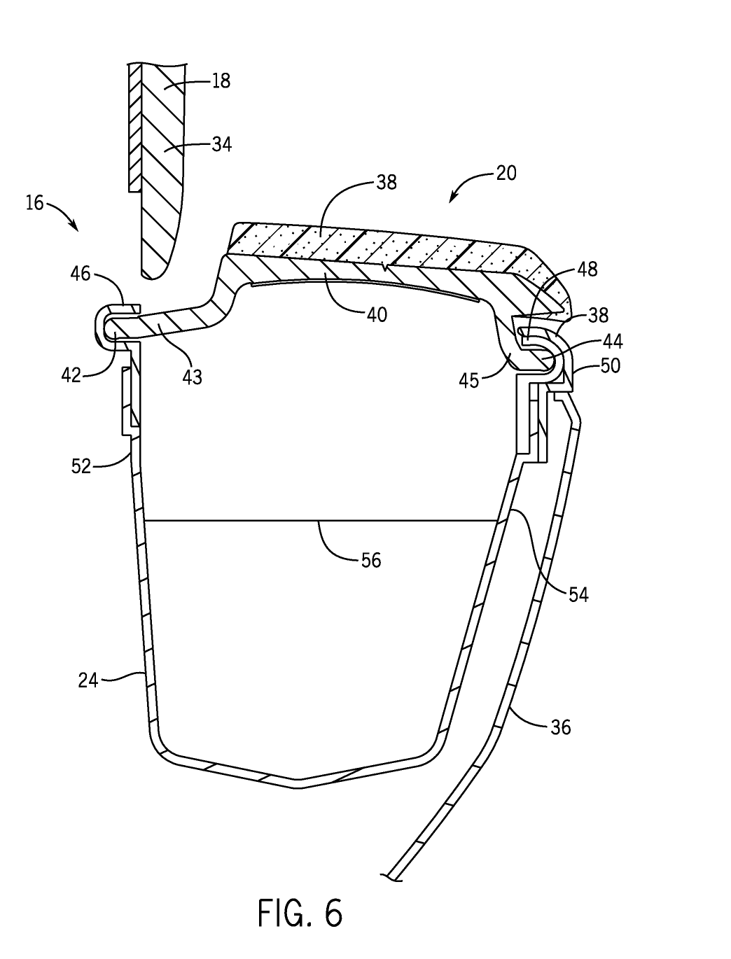

FIG. 6 is a cross-sectional view of an embodiment of the armrest 20 of FIG. 2. As illustrated, the support structure 18 of the vehicle door assembly 16 includes a first interior surface 34 and a second interior surface 36. The storage compartment 24 is located vertically below the first interior surface 34, and adjacent to the second interior surface 36. Moreover, the armrest 20 is slidably coupled to the storage compartment 24. The armrest 20 includes a cushion 38 formed over multiple support ribs 40. The cushion 38 provides a comfortable surface for an occupant of the vehicle to rest an arm. Each support rib 40 of the armrest 20 includes one or more protrusions 42 on a first end 43 and one or more protrusions 44 on a second end 45. The protrusions 42 and 44 are engaged within respective tracks 46 and 48, and configured to slide within the tracks. As illustrated, trim 50 may be positioned over an upper end of the storage compartment 24.

The storage compartment 24 includes a first side wall 52 and a second side wall 54. A support device 56 (e.g., bracket, flexible strap, nylon belt or strap, plastic strap, etc.) extends between the first side wall 52 and the second side wall 54, and is configured to provide structural support to the first side wall 52 and to the second side wall 54. The support device 56 may be configured to block movement of the first side wall 52 away from the second side wall 54.

As described above, the armrest 20 includes protrusions 42 and 44 that are configured to slide within tracks 46 and 48. Thus, the armrest 20 is slidably coupled to the tracks 46 and 48. Accordingly, the armrest 20 may slide between the aft position 26 and the forward position 28. With the armrest 20 being slidable, an occupant of the vehicle 10 may adjust the armrest to a desired position.

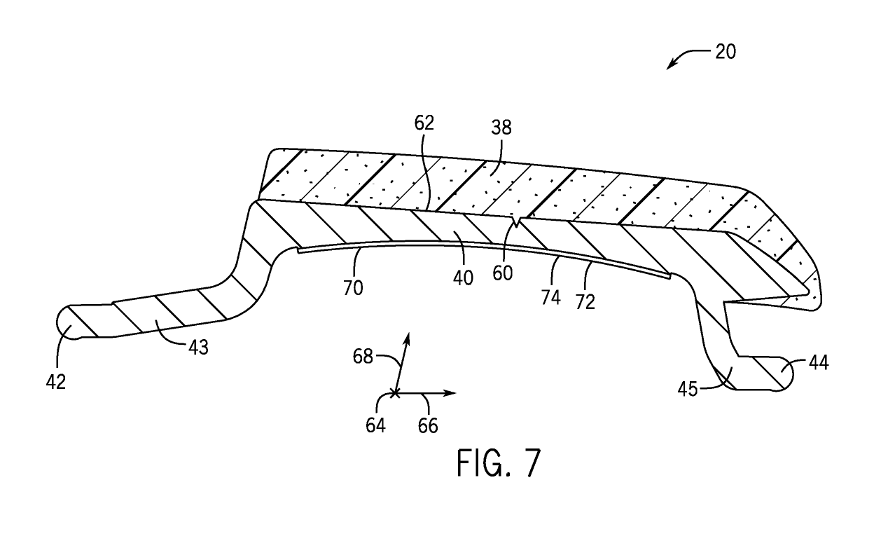

FIG. 7 is a cross-sectional view of another embodiment of the armrest 20 of FIG. 2. In the illustrated embodiment, each support rib 40 includes a notch 60 (e.g., stress concentration notch) extending along a first surface 62. Moreover, the notch 60 is positioned between the first end 43 and the second end 45. The notch 60 extends along each support rib 40 in a transverse direction 64 relative to a longitudinal direction 66, and the notch 60 extends substantially parallel to a plane formed by the first surface 62. In certain embodiments, the notch 60 may be positioned in a central lateral position between the first end 43 and the second end 45. The notch 60 is positioned such that as each support rib 40 is compressed longitudinally (e.g., by the first end 43 and the second end 45 compressing toward one another), the support rib 40 breaks and/or hinges at or near the notch 60 position, thereby enabling each support rib 40 to fold upon itself when compressed longitudinally. For example, the notch 60 may be directed in a vertical direction 68 and the first end 43 may fold toward the second end 45 such that a first portion 70 of a second surface 72 is adjacent to a second portion 74 of the second surface 72 when folded. Thus, energy from a longitudinal impact may be absorbed by each support rib 40.

As may be appreciated, the material of the cushion 38 may be disposed over the support ribs 40 and may cover and/or fill the notches 60 in the support ribs 40. While in the illustrated embodiment notches 60 are formed in each support rib 40, it should be noted that notches 60 may be formed in any suitable substrate of an armrest 20 to enable the substrate to fold upon itself when compressed longitudinally. For example, notches 60 may be formed in an armrest 20 in a vehicle door assembly, in an armrest in a center console, in an armrest in a floor console, in any suitable armrest, and/or in any suitable structure.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A vehicle door assembly comprising:
a support structure; and
an armrest slidably coupled to the support structure.

2. The vehicle door assembly of claim 1, wherein the armrest is configured to slide horizontally along the support structure.

3. The vehicle door assembly of claim 1, wherein the armrest comprises protrusions configured to engage tracks of the support structure.

4. The vehicle door assembly of claim 1, comprising a storage compartment disposed vertically below the armrest.

5. The vehicle door assembly of claim 4, wherein the armrest is configured to selectively cover at least a portion of an opening in the storage compartment.

6. The vehicle door assembly of claim 5, wherein the armrest is configured to slide between a first position that blocks access to an area of the storage compartment, and a second position that enables access to the area of the storage compartment.

7. The vehicle door assembly of claim 1, wherein the armrest comprises a cushion.

8. The vehicle door assembly of claim 1, wherein the armrest comprises a flexible material configured to enable the armrest to slide along a non-linear track.

9. The vehicle door assembly of claim 1, wherein the armrest is configured to slide at least partially in a vertical direction.

10. The vehicle door assembly of claim 1, wherein the armrest is configured to provide structural support for loading.

11. The vehicle door assembly of claim 1, wherein the support structure comprises a support device disposed under the armrest, and configured to provide support to the vehicle door assembly.

12. The vehicle door assembly of claim 1, wherein the support structure comprises a bracket or strap configured to provide support to the vehicle door assembly.

13. An armrest assembly comprising:
a substrate having a first surface and a second surface, wherein the first surface comprises a notch extending along the first surface in a transverse direction relative to a longitudinal direction, and the notch extends substantially parallel to a plane formed by the first surface.

14. The armrest assembly of claim 13, comprising:
a support structure comprising a first wall having a first track, and a second wall having a second track; and
an armrest slidably coupled to the support structure, wherein the armrest comprises protrusions configured to engage the first track of the first wall and the second track of the second wall, and wherein the armrest comprises the substrate.

15. The armrest assembly of claim 13, comprising a cushion disposed over the first surface of the substrate.

16. The armrest assembly of claim 13, wherein the substrate comprises a flexible material configured to enable the armrest to slide along non-linear tracks.

17. A vehicle door assembly comprising:
a slidable armrest configured to move in a substantially horizontal direction relative to a longitudinal axis of the vehicle door assembly.

18. The vehicle door assembly of claim 17, comprising a storage compartment disposed vertically below the armrest.

19. The vehicle door assembly of claim 18, wherein the armrest is configured to selectively cover at least a portion of an opening in the storage compartment.

20. The vehicle door assembly of claim 17, wherein the armrest is formed directly over a structure not used for storage.
